(19) United States
(12) Patent Application Publication
(10) Pub. No.: US 2003/0226644 A1
(43) Pub. Date: Dec. 11, 2003

(54) Operating unit for a window covering

(76) Inventors: Hermanus Marinus Ignatius Koot, SE Montfoort (NL); Frederik Meenks, EG Woerden (NL)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/430,741

(22) Filed: May 6, 2003

(30) Foreign Application Priority Data
May 6, 2002 (NL) NL 1 020 541
Dec. 6, 2002 (NL) NL 1 022 103

(51) Int. Cl. E06B 3/48

(52) U.S. Cl. 160/84.02

(57) ABSTRACT

A window covering operating unit including a stationary mountable first profile, a stationary mountable second profile, a profile movable between the first and second profile; and window covering material which is mountable between the movable profile and the first or second profile, wherein the window operating unit includes a first rotatable winding shaft which is arranged in a stationary profile and on which can be wound and unwound a first winding cord engaging on the movable profile and wherein the window operating unit further includes a second rotatable winding shaft which is arranged in a stationary profile and on which can be wound and unwound a second winding cord engaging on the movable profile, wherein the second winding shaft extends adjacently of and substantially parallel to the first winding shaft.

### TECHNICAL FIELD

The present invention generally relates to window coverings and more particularly relates to an operating unit for operating a window covering.

### BACKGROUND OF THE INVENTION

Such a type of window covering is also known as a blind. The window covering material is formed here by pleated or cellular curtains. Such a window covering is applied for instance in roof lights or in the sloping roof panels of conservatories. Although such window covering are usually installed obliquely, they are also used horizontally or vertically. A characteristic of blinds is that they have at least three profiles. A first profile and a second profile, or the upper and lower profile in an application which is other than horizontal, are mounted fixedly on or in the window frame, while a third profile, which is movable, is placed therebetween. The material of the curtain lies between the upper profile and the movable profile and/or between the lower profile and the movable profile, depending on the configuration. It is also possible to provide covering material between the upper profile and the movable profile as well as between the lower profile and the movable profile. One or more support cords or tensioning cables can be provided to support the window covering material and optionally the movable profile. Some window covering material will sag without support cords. The window covering is most commonly rectangular, although other forms (triangular or trapezoidal) of window coverings are also known.

An operating unit moves the movable profile reciprocally by means of pull cords engaging on the movable profile.

Many existing operating units operate on the basis of friction wherein a continuous cord is wound several times round a roll and brought to tension. Friction between the roll and the cord provides transfer of movement. The more friction present during reciprocating movement of the movable profile, the more drive energy is lost. This phenomena makes battery operated units less suitable in battery-powered drive systems. Operating units are further known wherein use is made of one or more wind-up shafts. Although these encounter less friction and are therefore more suitable for the application of battery-powered systems, these known operating units do however have such large dimensions that they are not suitable, or at least less so, for relatively narrow and long windows. In addition, the existing operating units quite often meet with problems during winding up and/or subsequent unwinding of said pull cords.

It is therefore an object of the present invention to provide an operating unit for window coverings of the above stated type, wherein at least one of the above stated drawbacks or other problems associated with the prior art are obviated.

According to a first aspect of the present invention, there is provided for this purpose an operating unit which comprises displacing means for displacing the movable profile, the displacing means comprising:

a first rotatable winding shaft which is arranged in a stationary profile and on which can be wound and unwound a first and a third winding cord engaging on the movable profile;

a second rotatable winding shaft which is arranged in a stationary profile and on which can be wound and unwound a second and a fourth winding cord engaging on the movable profile, wherein the second winding shaft extends adjacently of and substantially parallel to the first winding shaft. By applying two winding shafts and positioning these adjacently of each other an extremely compact, operating unit can be realized. Assuming a cord diameter of for instance 0.8 mm, it is possible with the operating unit according to the invention to realize a window covering which is only 0.4 m wide, wherein the operating unit has a sufficient wind-up capacity to deal with a window covering length (height) of at least 4 m.

The operating unit comprises a third and fourth winding cord which can be wound and unwound on respectively the first and second winding shaft. It is particularly for the stability of the movable profile that the use of two sets of winding cords is recommended, wherein one set is positioned on each end of the movable profile. The first winding cord, and where necessary the fourth winding cord, is arranged for the purpose of pulling the movable profile in the direction of the first profile, while the second winding cord, and where necessary the third winding cord, is arranged for the purpose of pulling the movable profile in the direction of the second profile.

The winding cords can be fastened fixedly to the movable profile. It is however also possible to fasten the first and fourth and/or the second and third winding cord to each other. This has the advantage of simplifying alignment of the movable profile.

In another preferred embodiment the winding cords are connected resiliently to each other or the winding cords engage resiliently on the movable profile. The cords are hereby easy to tension and keep tensioned.

In a further preferred embodiment the operating unit comprises adjustable tensioning means for setting the tension on the winding cords. This means that after installation the tension on the cords can still be changed, preferably in the accessible movable profile.

In a further preferred embodiment both winding shafts, and preferably also the drive of the winding shafts, can be arranged in the same stationary profile. This has a number of advantages. One of the advantages is that mounting of the operating unit, beforehand in new systems or later in already existing systems, becomes simpler.

According to another aspect of the present invention, there is provided an operating unit which comprises displacing means for displacing the movable profile, which displacing means comprise at least one rotatable winding shaft for arranging in a stationary profile and on which can be wound and unwound a winding cord connecting to the movable profile; the winding shaft comprising:

a rotatably drivable inner shaft,

an outer shaft which is slidable over the inner shaft and arranged co-rotatably with the inner shaft and on which the winding cord can be wound and unwound,

shifting means for shifting the slidable outer shaft during unwinding and winding of the winding cord. Through the use of such a construction the winding cord is wound neatly onto the outer shaft, thereby reducing the chance of the winding cords becoming tangled with the possible consequence of the operating unit not functioning properly.

The outer surface of the outer shaft can have a smooth surface onto which the winding cord can be wound. In another preferred embodiment of the invention, the operating unit is provided with shifting means in the form of receiving grooves, preferably spiral-shaped, provided in the outer surface of the outer shaft for receiving the relevant winding cord. Due to the form of the grooves the relevant winding cord is compelled to be wound up in a spiral, thus preventing entanglement of the winding cord. The slidable outer shaft is shifted relative to the inner shaft by the forces occurring during winding-up.

In another preferred embodiment the shifting means comprise internal and external screw thread provided on the outer shaft and on a bearing unit of the inner shaft. During rotation of the inner shaft and the rotation of the outer shaft corresponding therewith, the screw thread ensures that the outer shaft is shifted relative to the inner shaft. The part of the outer surface of the outer shaft onto which the winding cord is wound can herein be smooth or can contain the above described grooves.

The operating unit preferably comprises an electric motor for driving one or more winding shafts, in the embodiments with two or more shafts preferably a single electric motor for driving all shafts, in addition to transmitting and receiving means for transferring control signals between a remote control and the electric motor. The electric motor, and preferably also the transmitting and receiving means, can herein be battery-powered. The battery supply is then fastened in or on the relevant profile.

### BRIEF DESCRIPTION OF THE DRAWINGS

FIG. 1 shows an exploded schematic view of a preferred embodiment of an operating unit for window covering; and

FIGS. 2a, 2b, 3a and 3b show partly cut-away views in perspective of preferred embodiments of the invention.

### DETAILED DESCRIPTION OF THE PREFERRED EMBODIMENTS

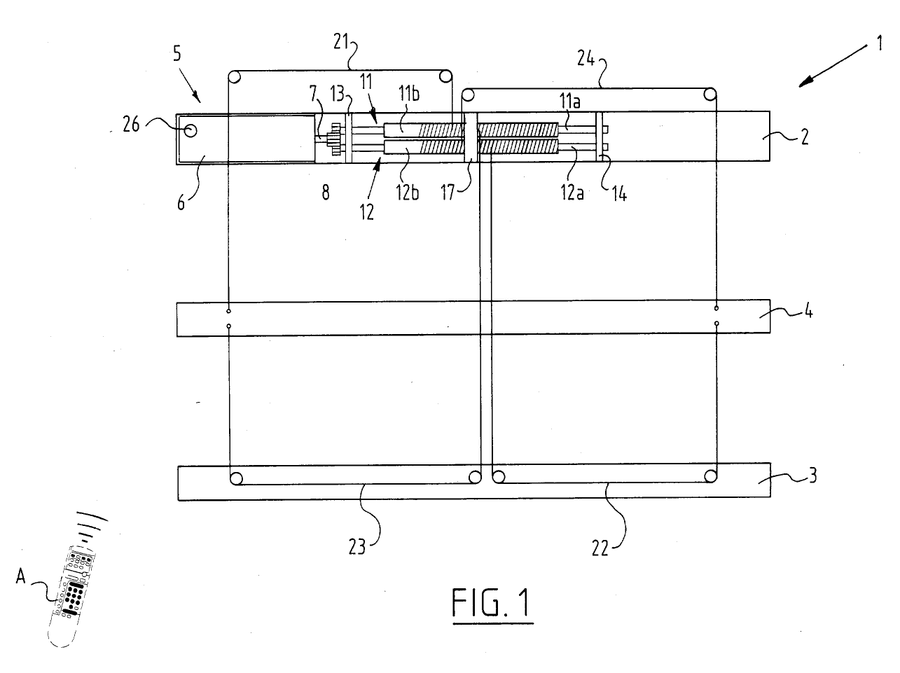

FIG. 1 shows a window covering 1 with an upper rail 2, a lower rail 3 and a rail 4 movable between upper rail 2 and lower rail 3. The fabric or fabrics with which the window can be covered is not shown for the sake of simplicity. The fabric can however be fastened in known manner to the movable rail 4 on one side and the upper or lower rail 2,3 on the other. The operating unit 5 with which the movable rail 4 can be operated is placed as a single unit in upper rail 2. Operating unit 5 comprises an electric motor 6 powered by a number of batteries (not shown) arranged in, on or close to upper rail 2. Drive shaft 7 of electric motor 6 drives a toothed wheel 8 which in turn drives the toothed wheels 9 and 10 of winding shafts 11 and 12.

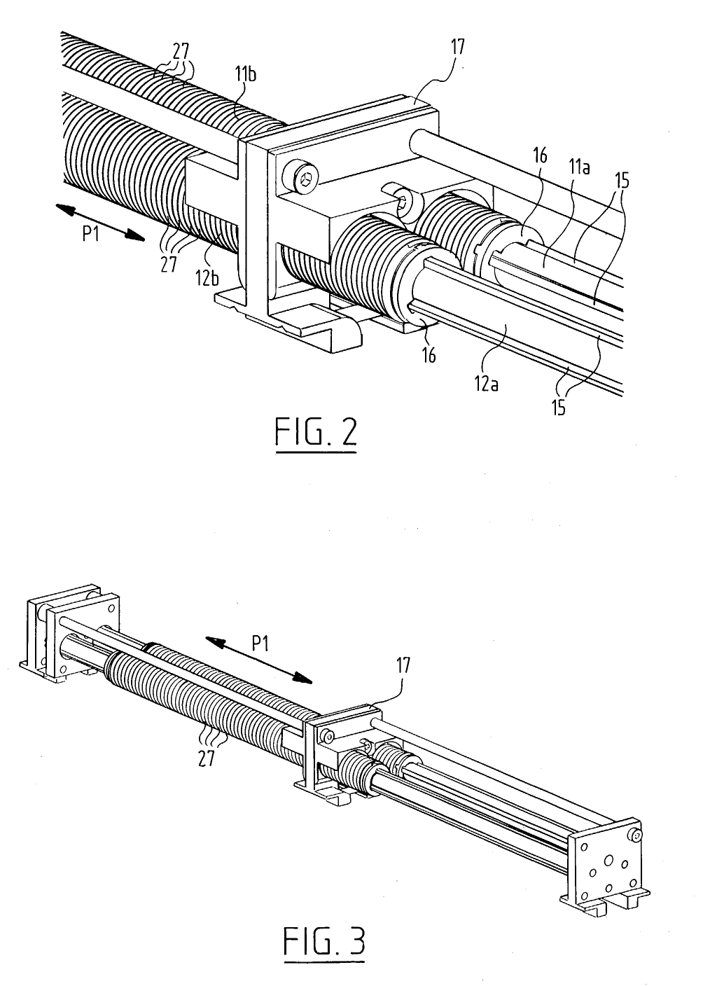

The two winding shafts 11 and 12 lie directly adjacently of each other in upper rail 2. Winding shafts 11,12 are constructed respectively from inner shafts 11a, 12a and outer shafts 11b and 12b. Outer shafts 11b,12b slide over inner shafts 11a and 12a respectively. Inner shafts 11a and 12a are both longer than their respectively associated inner shafts, and both inner shafts 11a,12a which are mounted at the two ends in bearing blocks 13 and 14. The slidable outer shafts 11b,12b co-rotate with inner shafts 11a,12a in that protrusions 15 (see FIG. 2) are provided on the inner shafts and corresponding recesses 16 on the outer shafts. Situated in the middle of the system, midway between the two bearing blocks, is a third block 17 where the four winding cords 21, 22, 23, 24 come together. The cords are guided with minimal friction to the slidable shafts 11b,12b by the third block 17.

Two sets of cords are necessary for the stability of movable rail 4, one on each side. One set consists of a cord with which the movable rail 4 can be pulled upward 21, 24, and a cord with which the movable rail 4 can be pulled downward 23, 22. Each set of cords is fixed to one of the slidable shafts, with one cord on each side. Prior to mounting, the cords which serve to lift 21,24 the movable rail 4, are fixed to one side of their respectively associated slidable shafts. This allows the cords 21, 24 to raise and lower the fabric.

The amount of cord that must be provided on the slidable shafts 11b,12b is a function of height of the curtain (or fabric), whereby the shafts 11b,12b are full or practically full only at the maximum retraction of the curtain, for instance a height of 4 meters or more. The cords for moving the movable rail 4 downward 23, 22 run straight downward mutually adjacently from the center, through the movable rail 4 to lower rail 3. They are there rerouted to the two sides of lower rail 3. The cords 22, 23 herein run, for instance, within an opening in lower rail 3. The cords are then guided upward to movable rail 4. Here they are fixed to movable rail 4, this in a manner such that they can be made tighter or looser. The two cords 21 and 24 for moving the movable rail 4 upward, are routed from the center to the two sides of upper rail 2, wherein the cords in upper rail 2 run below the wind-up system and motor 5 where they are rerouted downward to movable rail 4 or are fastened to each other. After installation of the operating unit in the window frame, the tension on the cords can be changed in the accessible movable rail 4 by way of an adjusting means (not shown).

The installed operating unit can be simply opened and closed by using a switch provided on a rail or by using a remote control A. In the latter case the motor 6 is activated by a signal transmittal from the infrared remote control A, which is received by a receiving infrared detector 26 and processed by control electronics (not shown). The motor drives the two shafts 11,12 of the wind-up mechanism. In the case of each shaft, cord is wound up on the one side and simultaneously cord is unwound on the other side. In the two extreme positions (fully open or fully closed) almost all cord is on one side. There are still a few windings on the other side so that the cord is never fully unwound. This enables a fine adjustment of the unit.

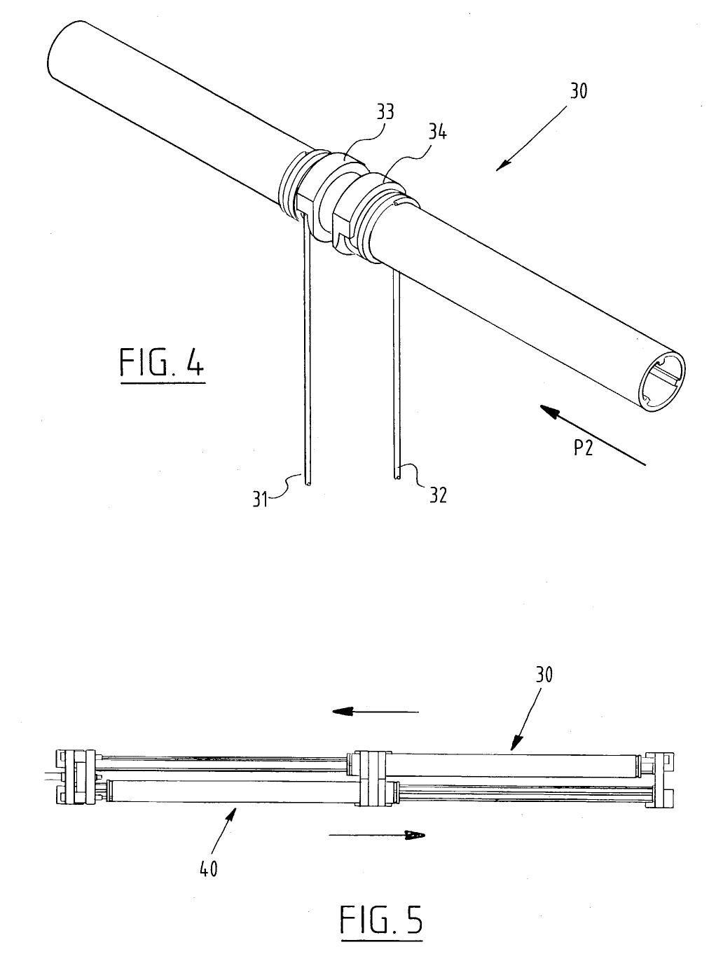

FIGS. 2a and 3b show that slidable outer shafts have an outer surface in which a spiral-shaped groove 27 is arranged. When the outer shafts are rotated the different winding cords are received in these grooves. These grooves per se can already bring about the required shifting of the outer shafts 11b,12b relative to inner shafts 11a,12a. In the disclosed embodiment, the middle block 17 is however also provided with grooves, this such that the grooves 27 in the outer shafts 11b,12b and the grooves in block 17 function as internal and external screw thread. This means that during rotation of inner shafts 11b and 12b and the corresponding rotation of outer shafts 11a and 11b, the outer shafts 11a and 12a are compelled to shift (arrow P) by virtue of the interaction between grooves 27 and 17. The result hereof is that the winding cords are wound up and unwound neatly.

The invention is not limited to the above described preferred embodiments thereof; the rights sought are defined by the following claims, within the scope of which many modifications can be envisaged.

1. Operating unit for operating a covering which wholly or partially covers or leaves clear as required at least one opening in a building structure, wherein the covering comprises a stationary mountable first profile, a stationary mountable second profile, a profile movable between the first and second profile; and covering material which is mountable between the movable profile and the first and/or second profile and with which the opening can be covered, wherein the operating unit comprises displacing means for displacing the movable profile, the displacing means comprising:
a first rotatable winding shaft (11) which is arranged in a stationary profile and on which can be wound and unwound a first and a third winding cord (21, 23) engaging on the movable profile;
a second rotatable winding shaft (12) which is arranged in a stationary profile and on which can be wound and unwound a second and a fourth winding cord (24, 22) engaging on the movable profile, wherein the second winding shaft (12) extends adjacently of and substantially parallel to the first winding shaft (11).

2. Operating unit as claimed in claim 1, wherein the first winding cord (21) and the second winding cord (24) are arranged for the purpose of pulling the movable profile in the direction of the first profile, while at least the third winding cord (23) and fourth winding cord (22) are arranged for the purpose of pulling the movable profile in the direction of the second profile.

3. Operating unit as claimed in claim 2, wherein the winding shafts are arranged in the first stationary profile, the first and second winding cords extend directly from the first profile to the movable profile and the third and fourth winding cords extend from the first profile to the movable profile via the second profile.

4. Operating unit as claimed in any of the foregoing claims, wherein the winding cords engage in the vicinity of the ends of the movable profile.

5. Operating unit as claimed in any of the claims 1-4, wherein the first and third winding cord and/or the second and fourth winding cord are fastened to each other.

6. Operating unit as claimed in claim 5, wherein the winding cords are connected resiliently to each other.

7. Operating unit as claimed in any of the foregoing claims, wherein the engagement of a winding cord on the movable profile takes a resilient form.

8. Operating unit as claimed in any of the foregoing claims, comprising adjustable tensioning means for adjusting the tension on the winding cords.

9. Operating unit as claimed in any of the foregoing claims, wherein both winding shafts are arranged in the same stationary profile.

10. Operating unit, preferably as claimed in any of the foregoing claims, for operating a covering which wholly or partially covers or leaves clear as required at least one opening in a building structure, wherein the covering comprises a stationary mountable first profile, a stationary mountable second profile, a profile movable between the first and second profile; and covering material which is mountable between the movable profile and the first and/or second profile and with which the opening can be covered, wherein the operating unit comprises displacing means for displacing the movable profile, which displacing means comprise at least one rotatable winding shaft for arranging in a stationary profile and on which can be wound and unwound a winding cord connecting to the movable profile; the winding shaft comprising:
a rotatably drivable inner shaft,
an outer shaft which is slidable over the inner shaft and arranged co-rotatably with the inner shaft and on which the winding cord can be wound and unwound,
shifting means for shifting the slidable outer shaft during unwinding and winding of the winding cord.

11. Operating unit as claimed in claim 10, wherein the shifting means comprise internal and external screw thread provided on the outer shaft and on a bearing unit of the inner shaft.

12. Operating unit as claimed in claim 10 or 11, wherein the shifting means are formed by receiving grooves, preferably spiral-shaped, provided in the outer surface of the outer shaft for receiving a winding cord.

13. Operating unit as claimed in any of the claims 10-12, wherein the shifting means comprise winding cord guides.

14. Operating unit as claimed in claim 13, wherein a winding cord guide groove provided with a pitch is arranged in a cord guide.

15. Operating unit as claimed in any of the foregoing claims, wherein the winding cords engaging on the same winding shaft are wound onto the winding shaft in opposing directions.

16. Operating unit as claimed in any of the foregoing claims, wherein the inner shafts have corresponding rotation directions and the outer shafts have opposing shifting directions.

17. Operating unit as claimed in any of the foregoing claims, also comprising support means, preferably tensioning cables stretchable between the first and second profile, for supporting the covering material in a hanging of the covering which is other than vertical.

18. Operating unit as claimed in any of the foregoing claims, comprising an electric motor for driving one or more winding shafts, in addition to transmitting and receiving means for transferring control signals between a remote control and the electric motor.

19. Operating unit as claimed in claim 18, comprising a battery unit for arranging in or on a profile for power supply to the electric motor.

20. Operating unit as claimed in any of the foregoing claims, wherein the covering is a window covering with which at least one window can be covered.

21. Method for operating a covering, wherein the operating unit as claimed in any of the foregoing claims is applied.
